(19) United States
(12) Patent Application Publication
(10) Pub. No.: US 2018/0174345 A1
(43) Pub. Date: Jun. 21, 2018

(54) NON-TRANSITORY COMPUTER-READABLE STORAGE MEDIUM, DISPLAY CONTROL DEVICE AND DISPLAY CONTROL METHOD

(71) Applicant: Fujitsu Limited, Kawasaki-shi (JP)

(72) Inventor: Jumpei Yamanaka, Kawasaki (JP)

(73) Assignee: Fujitsu Limited, Kawasaki-shi (JP)

(21) Appl. No.: 15/840,894

(22) Filed: Dec. 13, 2017

(30) Foreign Application Priority Data
Dec. 16, 2016 (JP) 2016-244590

(51) Int. Cl. G06T 11/60; G06T 7/70

(52) U.S. Cl. CPC G06T 11/60; G06T 2207/30204; G06T 7/70

(57) ABSTRACT

A non-transitory computer-readable storage medium storing a display control program that causes a computer to execute a process including detecting a reference object is included in a captured image, obtaining superimposed data corresponding to the reference object, determining whether the superimposed data is entirely displayable in a predetermined area of an image when the superimposed data is superimposed on the image at a specified position with a specified size, the specified position being determined based on a position of the reference object in the image, the specified size being determined based on a size of the reference object, superimposing the superimposed data on the image at the specified position with the specified size when the superimposed data is entirely displayable in the predetermined area, and superimposing a modified superimposed data on the image when the superimposed data is not entirely displayable in the predetermined area.

### CROSS-REFERENCE TO RELATED APPLICATION

This application is based upon and claims the benefit of priority of the prior Japanese Patent Application No. 2016-244590, filed on Dec. 16, 2016, the entire contents of which are incorporated herein by reference.

### FIELD

The embodiments discussed herein are related to a non-transitory computer-readable storage medium, a display control method, and a display control device.

### BACKGROUND

In recent years, augmented reality (AR) techniques that display a content in a superimposed manner on a captured image using, for example, a smartphone, a tablet terminal, or the like are proposed. In such AR techniques, for example, when a terminal is directed to an object in order to capture an image, a content is superimposed on the captured image for display based on the information on the position and the direction of the terminal and a reference object included in the captured image, for example, an AR marker. Also, when additional information corresponding to an AR marker is superimposed on a captured image, changing the display scale factor of the additional information is proposed. Further, when an AR object that is superimposed to a plurality of users, disposing the AR object on a displayed image at an easily visible position to all the users is proposed.

Related-art techniques are disclosed in Japanese Laid-open Patent Publication Nos. 2016-057927 and 2014-203175.

### SUMMARY

According to an aspect of the invention, a non-transitory computer-readable storage medium storing a display control program that causes a computer to execute a process, the process including detecting a reference object is included in a captured image, obtaining superimposed data corresponding to the reference object from a memory, determining whether the superimposed data is entirely displayable in a predetermined area of an image when the superimposed data is superimposed on the image at a specified position with a specified size, the specified position being determined based on a position of the reference object in the image, the specified size being determined based on a size of the reference object, superimposing the superimposed data on the image at the specified position with the specified size when the superimposed data is entirely displayable in the predetermined area, and superimposing a modified superimposed data on the image when the superimposed data is not entirely displayable in the predetermined area, the modified superimposed data being the superimposed data of which at least one of a size and a position is changed from the specified position and the specified size.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of the configuration of a display control device according to a first embodiment;

FIG. 2 is a diagram illustrating an example of a content storage unit;

FIG. 3 is a diagram illustrating an example of a content attribute storage unit;

FIG. 4 is a diagram illustrating an example of a content having a size larger than that of the screen;

FIG. 5 is a diagram illustrating an example of reduction of a content;

FIG. 6 is a diagram illustrating an example of movement of a content;

FIG. 7 is a flowchart illustrating an example of display control processing according to the first embodiment;

FIG. 8 is a flowchart illustrating an example of content adjustment processing according to the first embodiment;

FIG. 9 is a block diagram illustrating an example of the configuration of a display control device according to a second embodiment;

FIG. 10 is a diagram illustrating an example of a content having a size larger than that of a screen and including characters;

FIG. 11 is a diagram illustrating an example of the case where a content including a character is reduced;

FIG. 12 is a diagram illustrating an example of movement of a content including a character;

FIG. 13 is a diagram illustrating an example of a content in which a specific position of a size larger than that of the screen is emphasized;

FIG. 14 is a diagram illustrating an example of reduction of a content having a specific position emphasized;

FIG. 15 is a diagram illustrating an example of movement of a content having a specific position emphasized;

FIG. 16 is a flowchart illustrating an example of content adjustment processing according to the second embodiment; and

FIG. 17 is a diagram illustrating an example of a computer that executes a display control program.

### DESCRIPTION OF EMBODIMENTS

However, for example, when the display position and the size of a content are set relative to the position and the size of a reference object in a screen, a part of or all of the content associated with the reference object is sometimes disposed outside the screen. For example, when a user zooms in a camera in order to display the reference object in an enlarged size, the content associated with the reference object is sometimes enlarged in size in the same manner and protrudes from the screen. Accordingly, it becomes not possible for the user to view all the information of the content, and thus the visibility of the content, that is to say, the superimposed data sometimes deteriorates.

According to an aspect of the present disclosure, it is desirable to provide a display control program, a display control method, and a display control device that are capable of reducing the deterioration of the visibility of superimposed data.

In the following, detailed descriptions will be given of a display control program, a display control method, and a display control device according to embodiments of the present disclosure with reference to the drawings. In this regard, the disclosed techniques are not limited by these embodiments. Also, it may be possible to suitably combine the following embodiments within a range in which inconsistency does not arise.

### First Embodiment

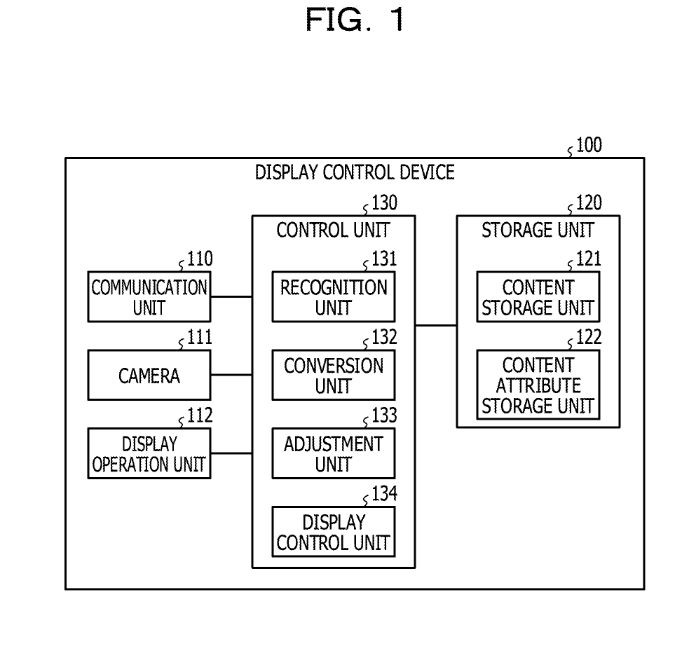

FIG. 1 is a block diagram illustrating an example of the configuration of a display control device according to a first embodiment. A display control device 100 illustrated in FIG. 1 is an example of an information processing apparatus in which if a reference object, for example, an AR marker is included in an image captured by a camera, superimposed data associated with the AR marker, that is to say, a content is superimposed on the captured image. For the display control device 100, it is possible to use a mobile communication terminal, or the like, for example, a tablet terminal, a smartphone, or the like.

When a captured image includes a reference object, the display control device 100 determines whether or not the type of the superimposed data corresponding to the reference object is a specific type. The display control device 100 detects that the type of the superimposed data is the specific type, and that the superimposed data of the predetermined size is not accommodated in a predetermined area of the captured image (namely, that the superimposed data of the predetermined size is not entirely displayable in a predetermined area of the captured image) when the superimposed data of a predetermined size is disposed at a position having a positional relationship with the reference object in the captured image. If the display control device 100 detects that the superimposed data of the predetermined size is not accommodated, the display control device 100 adjusts the disposed position or the size of the superimposed data so as to accommodate the superimposed data in the predetermined area. The display control device 100 superimposes the superimposed data having been subjected to the adjustment on the captured image. Thereby, it is possible for the display control device 100 to reduce deterioration of the visibility of the superimposed data.

Next, a description will be given of the configuration of the display control device 100. As illustrated in FIG. 1, the display control device 100 includes a communication unit 110, a camera 111, a display operation unit 112, a storage unit 120, and a control unit 130. In this regard, the display control device 100 may include various functional units possessed by a well-known computer other than the functional units illustrated in FIG. 1, for example, functional units, such as various input devices, an audio output device, or the like.

The communication unit 110 is realized by a mobile phone line, for example, a third generation mobile communication system, Long Term Evolution (LTE), or the like, and a wireless local area network (LAN), or the like. The communication unit 110 is connected to a server via an unillustrated network, and is a communication interface that controls communication of the information with the server. The communication unit 110 receives a content and a content attribute, which are examples of the superimposed data, from the server, and outputs the received content and content attribute to the control unit 130.

The camera 111 is an example of an imaging apparatus and disposed, for example, on the back face of the display control device 100, that is to say, on the opposite face to the display operation unit 112, and captures an image of the surroundings. The camera 111 captures an image using, for example, a complementary metal oxide semiconductor (CMOS) image sensor, a charge coupled device (CCD) image sensor, or the like as an imaging element. The camera 111 performs photoelectric conversion on the light received by the imaging elements, and performs analog-to-digital (A/D) conversion to generate an image. The camera 111 outputs the generated image to the control unit 130.

The display operation unit 112 is a display device for displaying various kinds of information and an input device for receiving various operations from a user. For example, the display operation unit 112 is realized by a liquid crystal display, or the like as a display device. Also, for example, the display operation unit 112 is realized by a touch panel, or the like as an input device. That is to say, the display operation unit 112 is integrated by a display device and an input device. The display operation unit 112 outputs the operation input by a user to the control unit 130 as operation information.

The storage unit 120 is realized by a storage device of a semiconductor memory device, or the like, for example, a random access memory (RAM), a flash memory, or the like. The storage unit 120 includes a content storage unit 121 and a content attribute storage unit 122. Also, the storage unit 120 stores information used for the processing by the control unit 130.

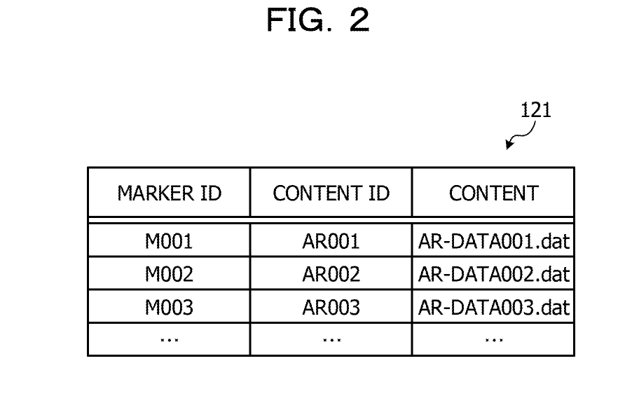

The content storage unit 121 stores a content obtained from the unillustrated server. FIG. 2 is a diagram illustrating an example of a content storage unit. As illustrated in FIG. 2, the content storage unit 121 has items, such as “marker ID (identifier)”, “content ID”, and “content”. The content storage unit 121 stores, for example, one record for each content ID.

The item “marker ID” is an identifier that identifies a reference object, that is to say, an AR marker. The item “content ID” is an identifier that identifies superimposed data, that is to say, a content. The item “content” is, for example, superimposed data, that is to say, a data file containing a content.

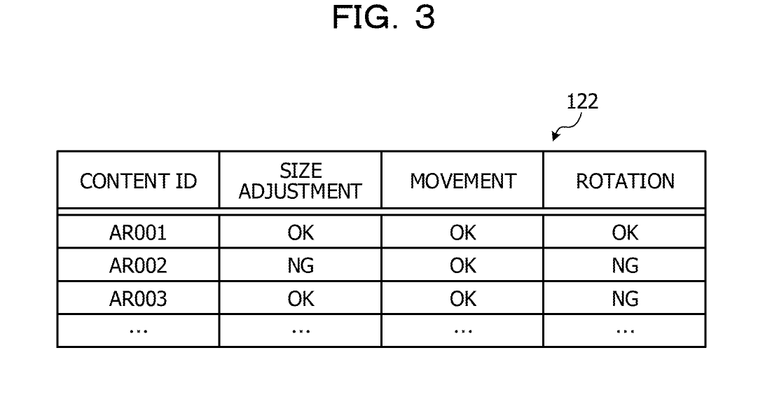

Referring back to FIG. 1, the content attribute storage unit 122 stores the attribute of a content in association with a content ID. FIG. 3 is a diagram illustrating an example of a content attribute storage unit. As illustrated in FIG. 3, the content attribute storage unit 122 has items, such as “content ID”, “size adjustment”, “movement”, and “rotation”. The content attribute storage unit 122 stores, for example, one record for each content ID.

The item “content ID” is an identifier that identifies superimposed data, that is to say, a content. The item “size adjustment” is an example of the attribute of a content and is information indicating whether or not the size of the content is adjustable. If the item “size adjustment” is “OK”, it indicates that the size is adjustable, and if the item “size adjustment” is “NG”, it indicates that the size is not adjustable. The item “movement” is an example of the attribute of a content and is information indicating whether or not the content is movable. If the item “movement” is “OK”, it indicates movable, and if the item “movement” is “NG”, it indicates not movable. The item “rotation” is an example of the attribute of a content and is information indicating whether or not the content is rotatable. If the item “rotation” is “OK”, it indicates rotatable, and if the item “rotation” is “NG”, it indicates nonrotatable.

Referring back to FIG. 1, the control unit 130 is realized, for example, by a central processing unit (CPU), a micro processing unit (MPU), or the like that executes a program stored in an internal storage device using a RAM as a work area. Also, the control unit 130 may be realized by an integrated circuit, for example, an application specific integrated circuit (ASIC), a field programmable gate array (FPGA), or the like.

The control unit 130 includes a recognition unit 131, a conversion unit 132, an adjustment unit 133, and a display control unit 134. The control unit 130 realizes or performs the information processing functions and operations described in the following. In this regard, the internal configuration of the control unit 130 is not limited to the configuration illustrated in FIG. 1, and may be another configuration as long as it is a configuration for performing the information processing described later. Also, the control unit 130 obtains a content and a content attribute from an unillustrated server in advance, stores the content in the content storage unit 121, and stores the content attribute in the content attribute storage unit 122.

For example, when a user inputs a start instruction for capturing an image, the recognition unit 131 instructs the camera 111 to start capturing an image. For example, inputting captured images to the recognition unit 131 from the camera 111 at predetermined time intervals is started. In this regard, the predetermined time intervals may be, for example, one second, and if the captured image is a moving image, for example, a frame rate of 30 fps may be used.

When the recognition unit 131 obtains a captured image from the camera 111, the recognition unit 131 performs recognition processing of a reference object, that is to say, an AR marker on the obtained captured image, and determines whether or not the AR marker has been recognized. If the recognition unit 131 has not recognized the AR marker, the processing proceeds to determination of whether or not to terminate the display control processing. If the recognition unit 131 has recognized the AR marker, the recognition unit 131 obtains the area information and the marker ID of the AR marker from the captured image. Also, the recognition unit 131 calculates the position coordinates and the rotational coordinates of the AR marker in the captured image based on the area information. The recognition unit 131 associates the calculated position coordinates and rotational coordinates with the marker ID and outputs the coordinates to the conversion unit 132.

When the conversion unit 132 receives the input of the marker ID and the position coordinates and rotational coordinates from the recognition unit 131, the conversion unit 132 obtains a content from the content storage unit 121 based on the marker ID. The conversion unit 132 performs model view conversion on the obtained content and further performs perspective transformation on the content in order to superimpose the content on the image for display. The conversion unit 132 outputs the marker ID and the converted content to the adjustment unit 133.

The adjustment unit 133 performs content adjustment processing in which one or more of the disposed position and the size of the content to be superimposed on the captured image are adjusted. When the adjustment unit 133 receives the input of the marker ID and the converted content from the conversion unit 132, the adjustment unit 133 refers to the content attribute storage unit 122 and obtains the attribute of the content. The adjustment unit 133 determines whether or not the converted content is reducible and movable based on the attribute of the obtained content. If the converted content is not both reducible and movable, the adjustment unit 133 outputs the marker ID and the converted content to the display control unit 134 and terminates the content adjustment processing. In this regard, the attribute of a content is an example of a specific type. Also, a specific type is a type based on the specification of permission or prohibition of change regarding one or more pieces of information out of the disposed position and the size of the superimposed data.

If the converted content is reducible and movable, the adjustment unit 133 calculates the size of the converted content on the screen displayed on the display operation unit 112. The adjustment unit 133 calculates, for example, the coordinate values of the converted content on the screen, for example, a width w_{c} and a height h_{c} corresponding to the number of pixels. When the adjustment unit 133 calculates the size of the converted content, the adjustment unit 133 determines whether or not the content is larger than the screen. For example, if either one of the width w_{c} and the height h_{c} of the converted content screen is larger than the products produced by multiplying a width W_{D} and a height H_{D} by a fixed value α (0 <a 1), respectively, the adjustment unit 133 determines that the converted content is larger than the screen. In this regard, if a determination criterion is set to the same size as that of the screen, the fixed value α becomes “1”. That is to say, if a slightly smaller size than the screen is used for the determination of whether or not the converted content is larger than the screen, for example, “0.9” is used for the fixed value α. That is to say, the content tends to be kept away from the screen ends by changing the fixed value α to a value smaller than “1”.

If the converted content is larger than the screen, the adjustment unit 133 reduces the content by a scale factor s illustrated by the following expression (1).

$$s = α \times min ( \frac{{W}_{D}}{{w}_{c}} , \frac{{H}_{D}}{{h}_{c}} ) \qquad ( 1 )$$

If the converted content is reduced, or the converted content is not larger than the screen, the adjustment unit 133 calculates the coordinate values of the four corners of the content. The adjustment unit 133 sets the coordinate values of the lower left corner of the screen to (0, 0) and sets the coordinate values of the upper right corner of the screen to (W_{D}, H_{D}), and calculates the coordinate values (xₗ, xᵣ) of the horizontal ends of the converted content and the coordinate values (yₜ, y_{b}) of the vertical ends of the converted content. The adjustment unit 133 compares the coordinate values of the screen and the coordinate values of the converted content, and determines whether or not there are superimposed parts of the converted content outside the screen. If there are no superimposed parts of the converted content outside the screen, the adjustment unit 133 outputs the marker ID and the converted content to the display control unit 134, and terminates the content adjustment processing.

If there is a superimposed part of the converted content outside the screen, the adjustment unit 133 moves the converted content so as to accommodate the converted content in the screen. If the coordinate value yₜ satisfies the following expression (2), the adjustment unit 133 calculates the amount of movement y_{d} in the downward direction by the following expression (³).

$$\begin{matrix}{y}_{t} > \frac{1 + α}{2} {H}_{D} & ( 2 ) \\ {y}_{d} = {y}_{t} - \frac{1 + α}{2} {H}_{D} & ( 3 )\end{matrix}$$

The adjustment unit 133 calculates coordinate values yₜ′ after the movement of the converted content by the following expression (4). In this regard, it is also possible to express the coordinate values yₜ′ after the movement by the following expression (5) using the coordinate values (W_{D}/2, H_{D}/2) of the center of the screen.

yₜ′=yₜ−y_{d} (4)

yₜ′=H_{D}/2 +αh_{D}/2 (5)

If the coordinate value y_{b} satisfies the following expression (6), the adjustment unit 133 calculates the amount of movement yᵤ in the vertical direction by the following expression (7).

$$\begin{matrix}{y}_{b} < \frac{1 - α}{2} {H}_{D} & ( 6 ) \\ {y}_{u} = \frac{1 - α}{2} {H}_{D} - {y}_{b} & ( 7 )\end{matrix}$$

The adjustment unit 133 calculates the coordinate value y_{b}′ of the converted content after the movement by the following expression (8).

y_{b}′=y_{b}+yᵤ (8)

The adjustment unit 133 calculates the amount of movement of the converted content and the coordinate values of the converted content after the movement in the horizontal direction in the same manner as in the vertical direction. In this case, the amount of movement (xᵣₛ, xₗₛ) in the horizontal direction correspond to the amount of movement (y_{d}, yᵤ) in the vertical direction in the expressions (2) to (8), and the coordinate values (xᵣ′, xₗ′) after the movement correspond to the (yₜ′, y_{b}′) in the expressions (2) to (8). Also, yₜ, y_{b}, and H_{D} in the expressions (2) to (8) are replaced with xᵣ, xₗ, and W_{D}.

When the adjustment unit 133 has moved the converted content, the adjustment unit 133 generates a line connecting the centers of the contents before and after the movement. For example, if the center of the content before the movement and the center of the AR marker are located at the same position, the adjustment unit 133 generates a line connecting the center of the content after the movement and the center of the AR marker. The adjustment unit 133 outputs the generated line, the marker ID, and the converted content to the display control unit 134, and the content adjustment processing is terminated.

That is to say, if the captured image includes a reference object, the adjustment unit 133 determines whether or not the type of the superimposed data corresponding to the reference object is a specific type. Also, if the adjustment unit 133 detects that the type of the superimposed data is the specific type, and that when the superimposed data of a predetermined size is disposed at the position having a predetermined positional relationship with the reference object in the captured image, the superimposed data of the predetermined size is not accommodated in the predetermined area of the captured image. Here, a position having a predetermined positional relationship with the reference object may be, for example, the center of the reference object, but may be a position specified in the stage of authoring a content in advance. Also, the predetermined size is the size of the converted content. In this regard, the predetermined area of the captured image is, for example, an area having a width of αW_{D} and a height of αH_{D}. Further, if the adjustment unit 133 determines that the superimposed data of the predetermined size is not accommodated, the adjustment unit 133 adjusts the disposed position or the size of the superimposed data so as to accommodate the superimposed data in the predetermined area.

When the display control unit 134 receives input of the marker ID and the converted content, or the generated line, the marker ID, and the converted content from the adjustment unit 133, the display control unit 134 determines whether or not all the contents corresponding to the AR marker in the captured image have been processed. If the display control unit 134 determines that not all the contents have been processed, the display control unit 134 instructs the conversion unit 132 to obtain the next content. If the display control unit 134 determines that all the contents have been processed, the display control unit 134 superimposes the converted content, that is to say, the content having been subjected to the content adjustment processing on the captured image to generate superimposed image data. At this time, if the display control unit 134 receives input of the generated line from the adjustment unit 133, the display control unit 134 also superimposes the line on the captured image to generate superimposed image data. The display control unit 134 causes the display operation unit 112 to display the generated superimposed image data.

In other words, the display control unit 134 displays the adjusted superimposed data on the captured image. Also, the display control unit 134 further superimposes display information indicating that the superimposed data having been subjected to adjustment of the disposed position corresponds to the reference object. Also, if the predetermined size of the superimposed data is larger than a value produced by multiplying the width or the height of the predetermined area by a predetermined fixed value, the display control unit 134 adjusts the size of the superimposed data based on the predetermined fixed value.

After the display control unit 134 causes the display operation unit 112 to display the superimposed image data, the display control unit 134 determines whether or not to terminate the display control processing. If the display control unit 134 does not terminate the display control processing, the display control unit 134 instructs the recognition unit 131 to obtain the next captured image. If the display control unit 134 terminates the display control processing, for example, the display control unit 134 outputs a stop instruction of capturing an image to the camera 111, and terminates the display control processing.

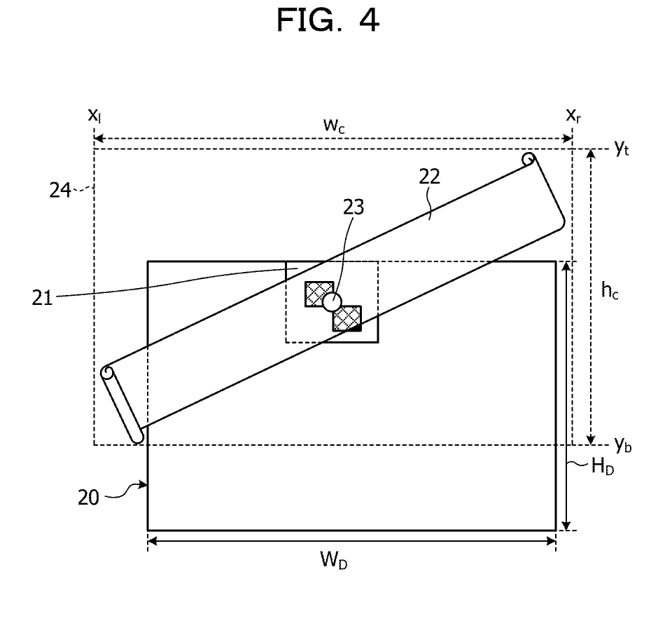

Here, descriptions will be given of reduction and movement of a content with reference to FIG. 4 to FIG. 6. FIG. 4 is a diagram illustrating an example of a content having a size larger than that of a screen. The example in FIG. 4 is the case where an AR marker 21 is located in the upper part of the screen 20. In this case, a content 22 associated with the center position 23 of the AR marker 21 is larger than the size of the screen 20, the content 22 protrudes from the screen 20. That is to say, the width w_{c} and the height h_{c} of an area 24 corresponding to the external form of the content 22 are larger than the width W_{D} and the height H_{D} of the screen 20, respectively. In this regard, the uppermost coordinate value of the area 24 is yₜ, the lowermost coordinate value is y_{b}, the leftmost coordinate value is xₗ, and the rightmost coordinate value is xᵣ.

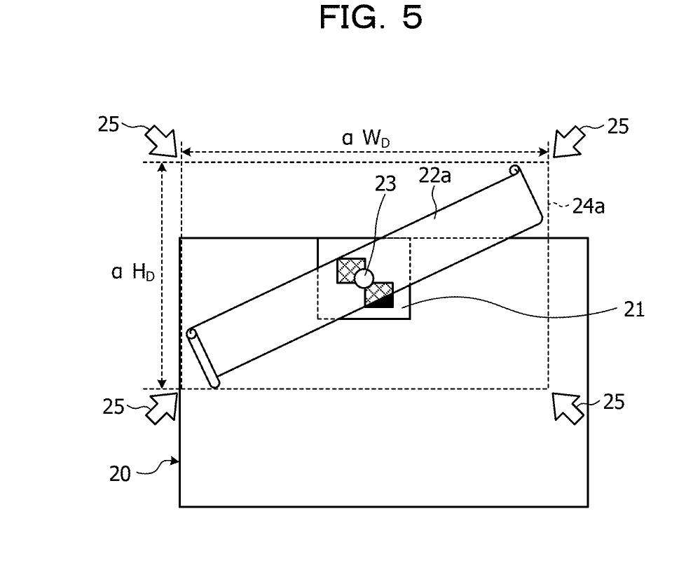

FIG. 5 is a diagram illustrating an example of reduction of a content. FIG. 5 is an example in which the content 22 illustrated in FIG. 4 is reduced so as to be accommodated in the screen. A content 22a illustrated in FIG. 5 is produced by reducing the content 22, and an area 24a corresponding to the external form of the content 22a comes to have a width of αW_{D} and a height of αH_{D}, which are produced by multiplying the width W_{D} and the height H_{D} of the screen 20 by a fixed value α, respectively. That is to say, the content 22a is reduced as illustrated by each arrow 25 with a center position 23 as center.

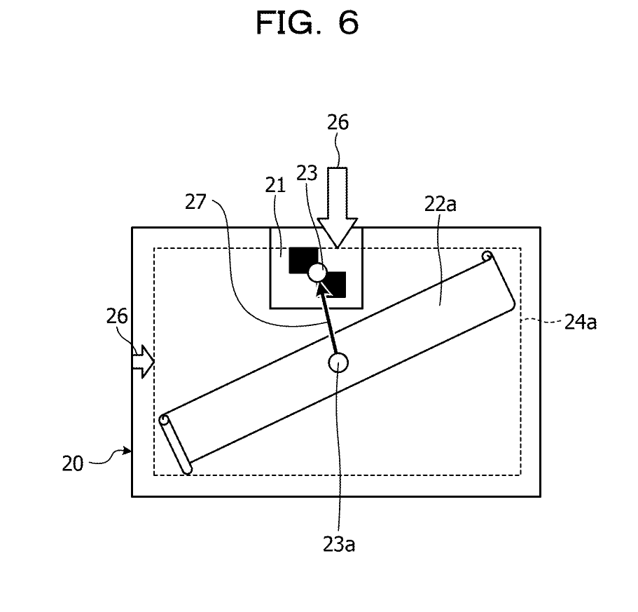

FIG. 6 is a diagram illustrating an example of movement of a content. FIG. 6 is an example in which the content 22a illustrated in FIG. 5 is moved in the center direction so as to be accommodated in the screen. The content 22a in FIG. 6 is moved from the state in FIG. 5 as illustrated by each arrow 26. That is to say, an area 24a corresponding to the external form of the content 22a is accommodated in the screen 20. Also, in the state in FIG. 6, a line arrow 27 indicating the movement of the content is displayed from a center position 23a of the content 22a to the center position 23 of the AR marker 21.

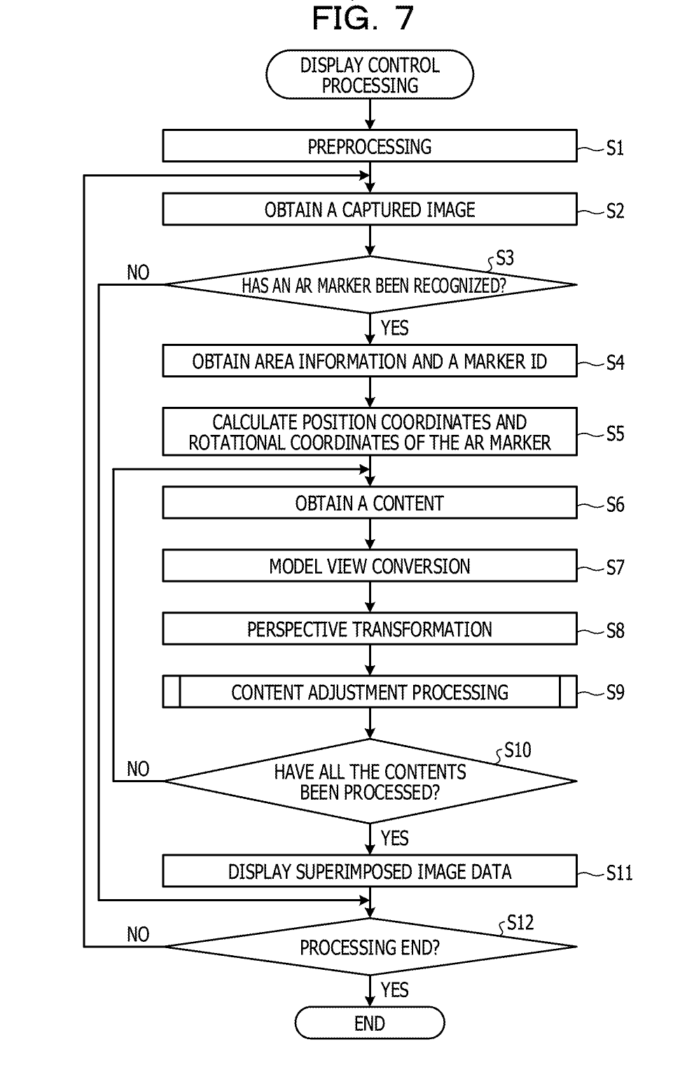

Next, a description will be given of the operation of the display control device 100 according to the first embodiment. FIG. 7 is a flowchart illustrating an example of display control processing according to the first embodiment.

The recognition unit 131 performs preprocessing for superimposing a content to be displayed on an AR marker (step S1). When the recognition unit 131 receives input of a start instruction by, for example, a user as the preprocessing, the recognition unit 131 instructs the camera 111 to start capturing an image. Captured images are started to be input in the recognition unit 131 from the camera 111, for example, at predetermined time intervals.

The recognition unit 131 obtains a captured image from the camera 111 (step S2). The recognition unit 131 determines whether or not an AR marker is recognized in the obtained captured image (step S3). If the recognition unit 131 has not recognized an AR marker (step S3: negation), the processing proceeds to step S12. If the recognition unit 131 has recognized an AR marker (step S3: affirmation), the recognition unit 131 obtains area information and a marker ID of the AR marker from the captured image (step S4). Also, the recognition unit 131 calculates the position coordinates and the rotational coordinates of the AR marker in the captured image based on the area information (step S5). The recognition unit 131 outputs the calculated position coordinates and the rotational coordinates to the conversion unit 132 in association with the marker ID.

When the conversion unit 132 receives input of the marker ID, the position coordinates, and the rotational coordinates from the recognition unit 131, the conversion unit 132 obtains a content from the content storage unit 121 based on the marker ID (step S6). The conversion unit 132 performs model view conversion on the obtained content (step S7), and further performs perspective transformation (step S8). The conversion unit 132 outputs the marker ID and the converted content to the adjustment unit 133.

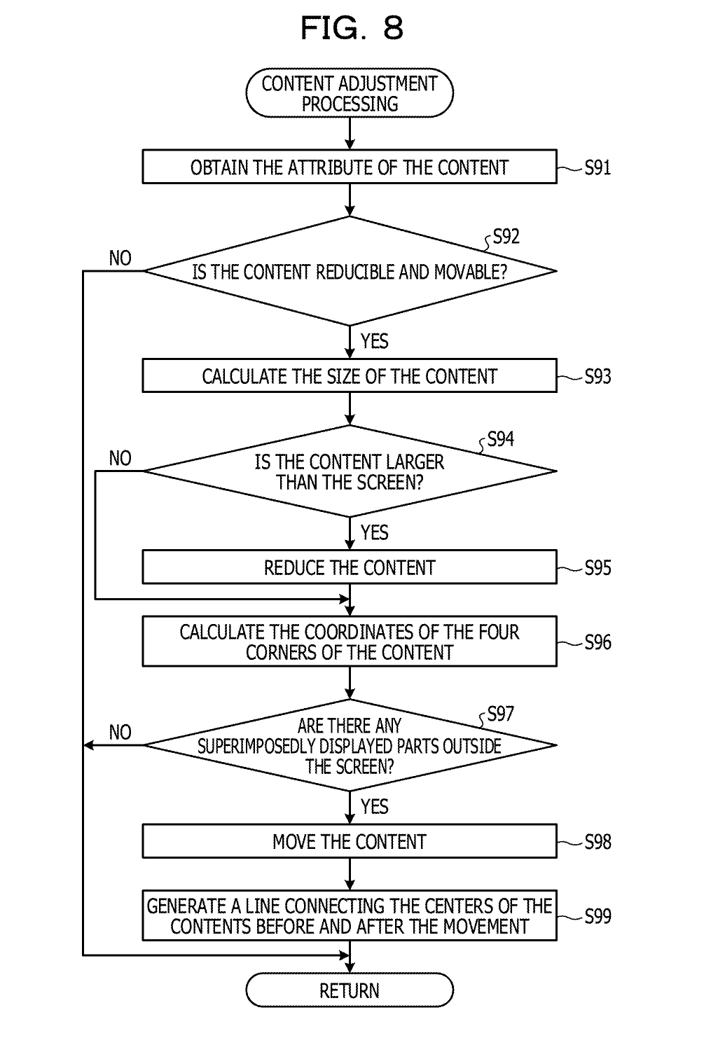

When the adjustment unit 133 receives the marker ID and the converted content from the conversion unit 132, the adjustment unit 133 performs the content adjustment processing (step S9). Here, a description will be given of the content adjustment processing with reference to FIG. 8. FIG. 8 is a flowchart illustrating an example of the content adjustment processing according to the first embodiment.

The adjustment unit 133 refers to the content attribute storage unit 122 based on the input marker ID and obtains the attribute of the content (step S91). The adjustment unit 133 determines whether or not the converted content is reducible and movable based on the attribute of the obtained content (step S92). If the converted content is not both reducible and movable (step S92: negation), the adjustment unit 133 outputs the marker ID and the converted content to the display control unit 134, terminates the content adjustment processing, and the processing returns the original processing.

If the converted content is reducible and movable (step S92: affirmation), the adjustment unit 133 calculates the size of the converted content on the screen displayed on the display operation unit 112 (step S93). After the adjustment unit 133 calculated the size of the converted content, the adjustment unit 133 determines whether or not the content is larger than the screen (step S94). If the converted content is larger than the screen (step S94: affirmation), the adjustment unit 133 reduces the content (step S95).

If the adjustment unit 133 has reduced the converted content in step S95, or the converted content is not larger than the screen (step S94: negation), the adjustment unit 133 calculates the coordinate values of the four corners of the content (step S96). The adjustment unit 133 compares the coordinate values of the screen and the coordinate values of the converted content, and determines whether or not there are superimposed parts of the converted content outside the screen (step S97). If there are no superimposed parts of the converted content outside the screen (step S97: negation), the adjustment unit 133 outputs the marker ID and the converted content to the display control unit 134 and terminates the content adjustment processing, and the processing returns to the original processing.

If there is a superimposed part of the converted content outside the screen (step S97: affirmation), the adjustment unit 133 moves the converted content so as to accommodate the converted content in the screen (step S98). After the adjustment unit 133 has moved the converted content, the adjustment unit 133 generates a line connecting the centers of the contents before and after the movement (step S99). The adjustment unit 133 outputs the generated line, the marker ID, and the converted content to the display control unit 134 and terminates the content adjustment processing, and the processing returns to the original processing. Thereby, it is possible for the adjustment unit 133 to reduce and move the content. That is to say, if the adjustment unit 133 detects that the content is not accommodated in the screen, it is possible for the adjustment unit 133 to adjust the disposed position and the size of the content so as to accommodate the content in the screen.

Referring back to FIG. 7, when the display control unit 134 receives input of the marker ID and the converted content, or the generated line, the marker ID, and the converted content from the adjustment unit 133, the display control unit 134 determines whether or not all the contents corresponding to the AR marker in the captured image have been processed (step S10). If the display control unit 134 determines that not all the contents have been processed (step S10: negation), the processing returns to step S6. That is to say, if a plurality of contents are associated with one AR marker, the display control unit 134 performs the adjustment processing on the individual contents.

If the display control unit 134 determines that all the contents have been processed (step S10: affirmation), the display control unit 134 superimposes the converted content and the generated line on the captured image to generate superimposed image data. The display control unit 134 displays the generated superimposed image data on the display operation unit 112 (step S11). After the display control unit 134 displays superimposed image data on the display operation unit 112, the display control unit 134 determines whether or not to terminate the display control processing (step S12). If the display control unit 134 does not terminate the display control processing (step S12: negation), the processing returns to step S2. If the display control unit 134 terminates the display control processing (step S12: affirmation), for example, the display control unit 134 outputs a stop instruction of capturing an image to the camera 111, and terminates the display control processing. Thereby, it is possible for the display control device 100 to reduce deterioration of the visibility of the content to be superimposed, that is to say, the superimposed data on the captured image.

In this manner, if a captured image includes a reference object, the display control device 100 determines whether or not the type of superimposed data corresponding to a reference object is a specific type. Also, the display control device 100 detects that the type of superimposed data is the specific type, and when the superimposed data having a predetermined size is disposed at a position having a predetermined positional relationship with the reference object in the captured image, the superimposed data of the predetermined size is not accommodated in a predetermined area in the captured image. Also, if the display control device 100 detects that the superimposed data of the predetermined size is not accommodated, the display control device 100 adjusts the disposed position or the size of the superimposed data such that the superimposed data is accommodated in the predetermined area. Also, the display control device 100 displays the superimposed data having been subjected to the adjustment on the captured image. As a result, it is possible for the display control device 100 to reduce deterioration of the visibility of the superimposed data.

Also, in the display control device 100, the specific type is a type based on the specification of permission or prohibition of change regarding one or more pieces of information out of the disposed position and the size of the superimposed data. As a result, it is possible for the display control device 100 to adjust the superimposed data in accordance with the adjustment possibility for each attribute of the content, that is to say, the superimposed data.

Also, the display control device 100 further superimposes display information indicating that the superimposed data having been subjected to disposed position adjustment corresponds to the reference object. As a result, it is possible for the display control device 100 to display the moved content, that is to say, the place where the superimposed data is originally displayed in an easy-to-understand manner.

Also, when the predetermined size of the superimposed data is larger than a value produced by multiplying the width or the height of the predetermined area by a predetermined fixed value, the display control device 100 adjusts the size of the superimposed data based on the predetermined fixed value. As a result, it is possible for the display control device 100 to keep the content after the adjustment away from the screen ends if possible.

### Second Embodiment

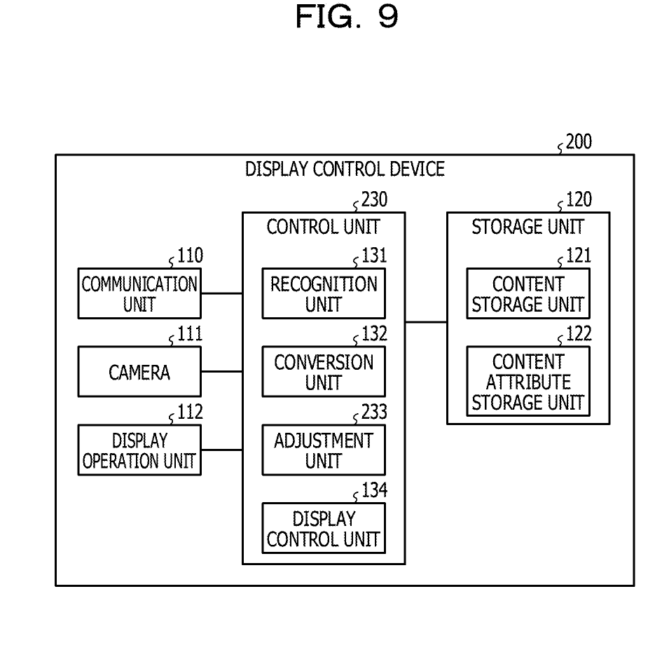

In the first embodiment, out of reduction and movement of a content, when both reduction and movement are possible, the content is reduced and moved. However, either reduction or movement may be carried out. In this case, a description will be given of an embodiment as a second embodiment. FIG. 9 is a block diagram illustrating an example of the configuration of a display control device according to the second embodiment. In this regard, the same reference sign is given to the same component as that in the display control device 100 according to the first embodiment. Thus, a description will be omitted of the duplicated component and the operation.

A display control device 200 according to the second embodiment includes a control unit 230 in place of the control unit 130 in comparison with the display control device 100 according to the first embodiment. Also, the control unit 230 includes an adjustment unit 233 in place of the adjustment unit 133 in comparison with the control unit 130 according to the first embodiment.

When the adjustment unit 233 receives input of the marker ID and the converted content from the conversion unit 132, the adjustment unit 233 refers to the content attribute storage unit 122 and obtains the attribute of the content. The adjustment unit 233 determines whether or not the converted content is reducible based on the attribute of the obtained content. If the converted content is not reducible, the adjustment unit 233 determines whether or not the content is movable. If the converted content is not reducible, for example, the case where the content includes characters is given. If the content includes characters, if reduction is carried out, characters become illegible and the readability deteriorates, and thus the item “size adjustment”, which is the attribute of the content attribute storage unit 122 is set to “NG”. That is to say, if the superimposed data includes characters, the adjustment unit 233 does not change the size of the superimposed data.

If the converted content is reducible, the adjustment unit 233 calculates the size of the converted content on the screen displayed on the display operation unit 112. In this regard, the calculation of the size is the same as that in the first embodiment, and thus the description will be omitted. After the adjustment unit 233 calculated the size of the converted content, the adjustment unit 233 determines whether or not the content is larger than the screen. If the converted content is larger than the screen, the adjustment unit 233 reduces the content by the scale factor s illustrated by the expression (1) in the same manner as in the first embodiment.

If the converted content is not reducible, if the converted content has been reduced, or if the converted content is not larger than the screen, the adjustment unit 233 determines whether or not the converted content is movable. If the converted content is not movable, the adjustment unit 233 outputs the marker ID and the converted content to the display control unit 134 and terminates the content adjustment processing.

If the converted content is reducible, the adjustment unit 233 calculates the coordinate values of the four corners of the content. In this regard, the calculation of the coordinate values is the same as that in the first embodiment, and thus the description will be omitted. The adjustment unit 233 compares the coordinate values of the screen and the coordinate values of the converted content, and determines whether or not there are superimposed parts of the converted content outside the screen. If there are no superimposed parts of the converted content outside the screen, the adjustment unit 233 outputs the marker ID and the converted content to the display control unit 134 and terminates the content adjustment processing.

If there is a superimposed part of the converted content outside the screen the converted content, the adjustment unit 233 moves the converted content so as to display the content in the screen as much as possible. The adjustment unit 233 compares the height h_{c} of the converted content and a value αH_{D} produced by multiplying the height of the screen by a fixed value α, and if a relationship h_{c}≤αH_{D} is satisfied, the same processing as that in the first embodiment is performed and the converted content is moved.

The adjustment unit 233 compares the height h_{c} and the value αH_{D}, and if a relationship h_{c}>αH_{D} is satisfied, adjustment unit 233 moves the content to the center of the screen. In this case, the vertical size of the converted content is larger than that of the screen, and thus the content is forced to protrude from the screen. However, the content is moved such that as a large part of the content as possible is displayed in the screen. The adjustment unit 233 calculates the amount of movement y_{ud} in the vertical direction using the following expression (9).

$${y}_{ud} = \frac{{H}_{D} - ( {y}_{t} + {y}_{b} )}{2} \qquad ( 9 )$$

The adjustment unit 233 calculates coordinate values (yₜ′, y_{b}′) after the movement of the converted content by the following expressions (10) and (11).

yₜ′=yₜ+y_{ud} (10)

y_{b}′=y_{b}+y_{ud} (11)

The adjustment unit 233 calculates the amount of movement of the converted content and the coordinate values after the movement in the horizontal direction in the same manner as in the vertical direction. In this case, the amount of movement xₗᵣ, in the horizontal direction corresponds to the amount of movement y_{ud} in the vertical direction in the expressions (9) to (11), and the coordinate values (xr′, xl′) after the movement correspond to (yₜ′, y_{b}′) in the expressions (9) to (11). Also, yₜ, y_{b}, and H_{D} in the expression ((9) is replaced with xᵣ, xₗ, and W_{D}.

When the adjustment unit 233 has moved the converted content, the adjustment unit 233 generates a line connecting the centers of the contents before and after the movement. The adjustment unit 233 outputs the generated line, the marker ID, and the converted content to the display control unit 134, and terminates the content adjustment processing.

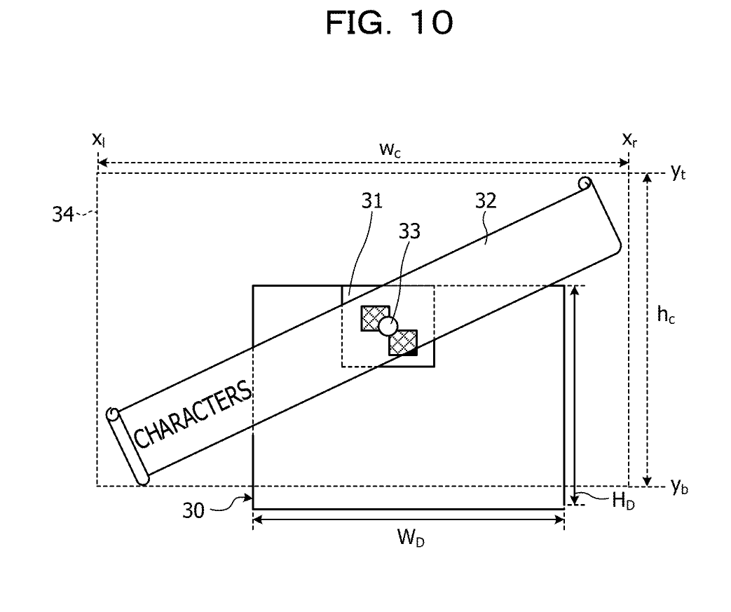

Here, a description will be given of an example of a content including characters with reference to FIG. 10 to FIG. 12. FIG. 10 is a diagram illustrating an example of a content having a size larger than that of a screen and including characters. The example in FIG. 10 is the case where an AR marker 31 is located at the upper part of a screen 30. In this case, a content 32 associated with the center position 33 of the AR marker 31 is larger than the size of the screen 30, and thus the content 32 protrudes from the screen 30. That is to say, an area 34 corresponding to the external form of the content 32 has a width w_{c} and a height h_{c}, which are larger than the width W_{D} and the height H_{D} of the screen 30 respectively. In this regard, the uppermost coordinate value of the area 34 is denoted by yₜ, the lowermost coordinate value is denoted by y_{b}, the leftmost coordinate value is denoted by xₗ, and the rightmost coordinate value is denoted by xᵣ. Also, the content 32 includes “characters” as characters.

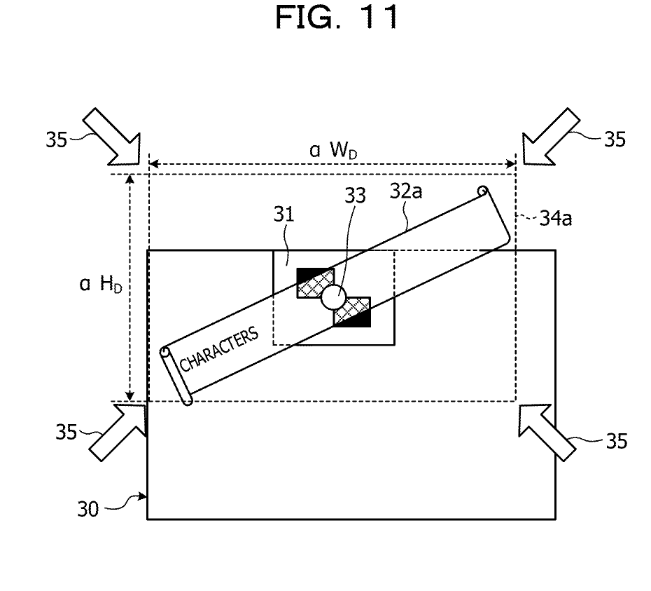

FIG. 11 is a diagram illustrating an example of the case where a content including a character is reduced. FIG. 11 is an example in the case where the content 32 illustrated in FIG. 10 is reduced to the size that is accommodated in the screen. A content 32a illustrated in FIG. 11 is produced by reducing the content 32, and an area 34a corresponding to the external form of the content 32a has a width αW_{D} and a height αH_{D}, which are the produced by multiplying the width W_{D} and the height H_{D} of the screen 30 by a fixed value α. That is to say, the content 32a is reduced as illustrated by each arrow 35 with a center position 33 as center. However, “characters”, which are characters included in the content 32a, become smaller compared with the content 32 in FIG. 10, and thus the characters sometimes become illegible. Accordingly, if an attribute of size adjustment “NG” is given to the content 32, the adjustment unit 233 moves the content 32 using the original size without reducing the content 32 as illustrated in FIG. 11.

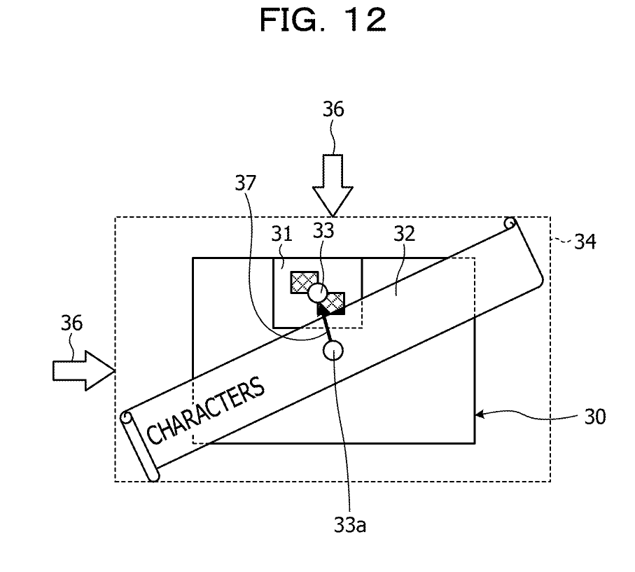

FIG. 12 is a diagram illustrating an example of movement of a content including a character. FIG. 12 is an example in the case where the content 32 illustrated in FIG. 10 is moved such that the center of the content 32 is moved to the center of the screen 30. The content 32 in FIG. 12 is moved from the state in FIG. 10 as illustrated by each arrow 36. That is to say, the area 34 corresponding to the external form of the content 32 is not accommodated in the screen 30, but the center of the area 34 is located at the center of the screen 30. Also, in the state in FIG. 12, a line arrow 37 indicating movement of a content is displayed from a center position 33a of the content 32 to the center position 33 of the AR marker 31. In this regard, in the example in FIG. 12, the characters are included in a part of the content 32 that is located outside the screen 30. When a user views the characters, for example, the user instructs to temporarily fix the display position of the content 32 with respect to the AR marker 31. Next, the user moves the display control device 200 including the camera 111 in the leftward direction so as to move the content 32 in the screen 30, and thus it is possible for the user to read the characters that are originally disposed outside the screen 30.

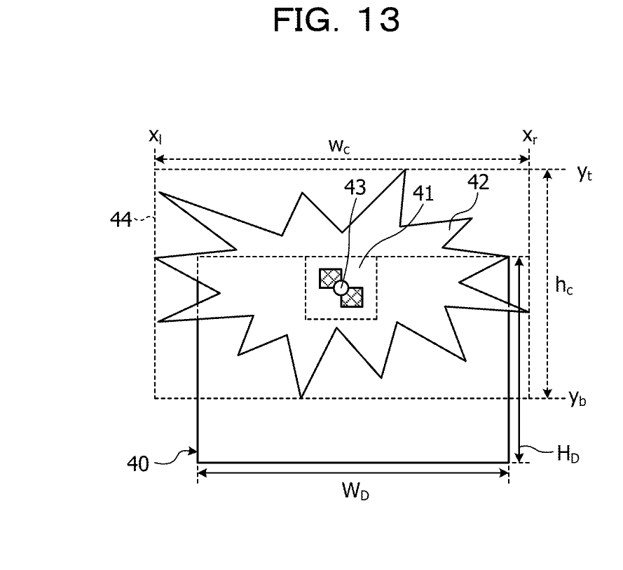

Next, a description will be given of an example of a content that emphasizes a specific position with reference to FIG. 13 to FIG. 15. FIG. 13 is a diagram illustrating an example of a content in which a specific position of a size larger than that of the screen is emphasized. The example in FIG. 13 is the case where an AR marker 41 is located in the upper part of a screen 40. In this case, a content 42 associated with the center position 43 of the AR marker 41 is larger than the size of the screen 40, and thus protrudes from the screen 40. That is to say, the width w_{c} and the height h_{c} of an area 44 corresponding to the external form of the content 42 are larger than the width W_{D} and the height H_{D} of the screen 40. In this regard, the uppermost coordinate value of the area 44 is denoted by yₜ, the lowermost coordinate value is denoted by y_{b}, the leftmost coordinate value is denoted by xₗ, and the rightmost coordinate value is denoted by xᵣ. Also, the content 42 is a content for emphasizing the center position 43 of the AR marker 41 in the screen 40.

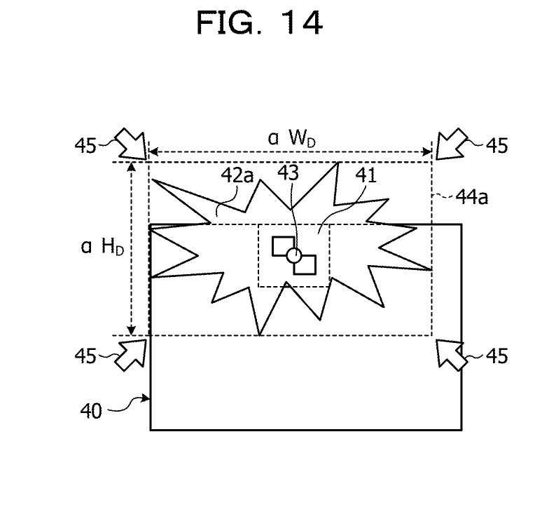

FIG. 14 is a diagram illustrating an example of reduction of a content having a specific position emphasized. FIG. 14 is an example of the case where the content 42 illustrated in FIG. 13 is reduced to the size that is accommodated in the screen. A content 42a illustrated in FIG. 14 is produced by reducing the content 42, and an area 44a corresponding to the external form of the content 42a has a width of αW_{D} and a height of αH_{D}, which are produced by multiplying the width W_{D} and the height H_{D} of the screen 40 by a fixed value α. That is to say, the content 42a is reduced as illustrated by each arrow 45 with the center position 43 as center. For example, if an attribute of the size adjustment of “OK” and the movement of “NG” is given to the content 42, it is not possible for the adjustment unit 233 to move the reduced content 42a as illustrated in FIG. 14. In this case, the content 42a is reduced, but is not moved from a specific position to be emphasized. Accordingly, the place to be emphasized is intuitively displayed.

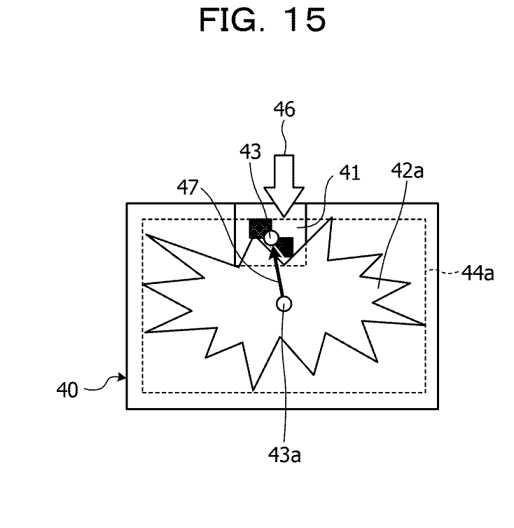

A content having a specific position to be emphasized, for example, when a content includes a character or a sign, it is sometimes better to move the content. FIG. 15 is a diagram illustrating an example of movement of a content having a specific position emphasized. FIG. 15 is an example of the case where the content 42a illustrated in FIG. 14 is moved in the direction of the center of the screen so as to be accommodated in the screen. The content 42a in FIG. 15 has been moved from the state in FIG. 14 as illustrated by each arrow 46. That is to say, the area 44a corresponding to the external form of the content 42a is accommodated in the screen 40. Also, in the state in FIG. 15, a line arrow 47 indicating the movement of the content is displayed from the center position 43a of the content 42a to the center position 43 of the AR marker 41.

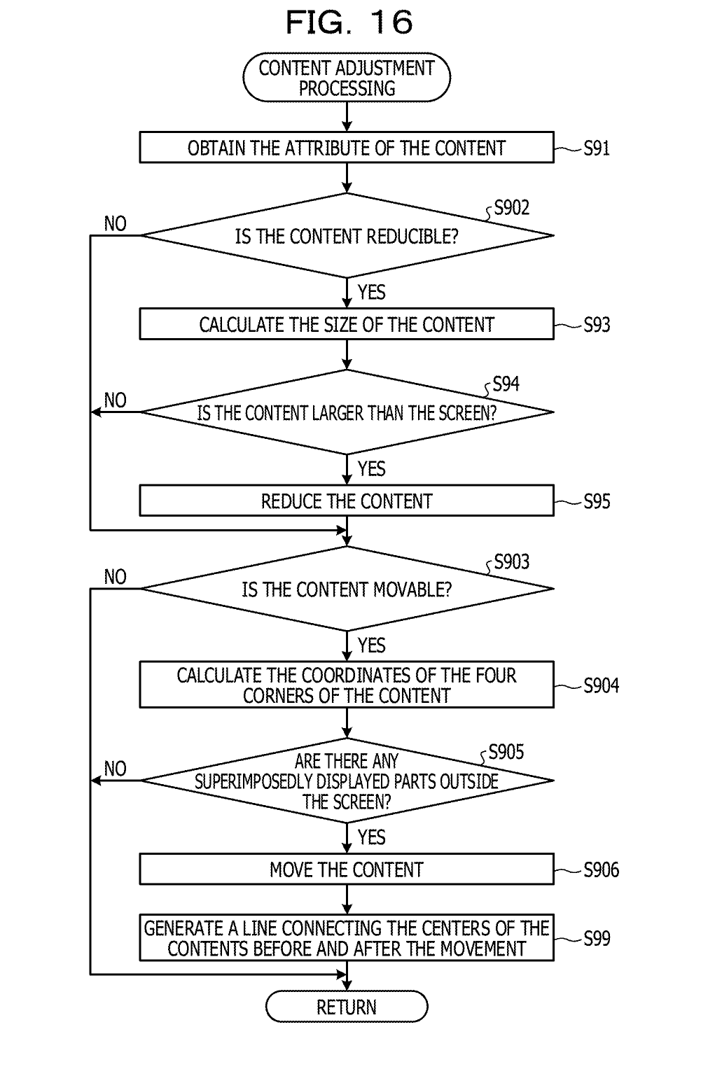

Next, a description will be given of the operation of the display control device 200 according to the second embodiment. FIG. 16 is a flowchart illustrating an example of content adjustment processing according to the second embodiment. In the following description, the processing in steps S1 to S8 and S10 to S12 in the display control processing is the same as those in the first embodiment, and thus the description thereof will be omitted. Also, the processing in steps S91, S93 to S95, and S99 out of the content adjustment processing of step S9 is the same as that in the first embodiment, and thus the description thereof will be omitted.

The adjustment unit 233 performs the following processing next to the processing in step S91. The adjustment unit 233 determines whether or not the converted content is reducible based on the attribute of the obtained content (step S902). If the adjustment unit 233 determines that the converted content is not reducible (step S902: negation), the processing proceeds to step S903.

If the adjustment unit 233 determines that the converted content is reducible (step S902: affirmation), the processing proceeds to step S93. Also, if the adjustment unit 233 determines that the processing result is negation in step S94, the processing proceeds to step S903.

If the processing result is negation in step S902, or the processing result is negation in step S94, or next to the processing in step S95, the adjustment unit 233 performs the next processing. The adjustment unit 233 determines whether or not the converted content is movable (step S903). If the converted content is not movable (step S903: negation), the adjustment unit 233 outputs the marker ID and the converted content to the display control unit 134 and terminates the content adjustment processing, and the processing returns to the original processing.

If the converted content is movable (step S903: affirmation), the adjustment unit 233 calculates the coordinate values of the four corners of the content (step S904). The adjustment unit 233 compares the coordinate values of the screen and the coordinate values of the converted content and determines whether or not there are superimposed parts of the converted content outside the screen (step S905). If there are no superimposed parts of the converted content outside the screen (step S905: negation), the adjustment unit 233 outputs the marker ID and the converted content to the display control unit 134 and terminates the content adjustment processing, and the processing returns to the original processing.

If there is a superimposed part of the converted content outside the screen (step S905: affirmation), the adjustment unit 233 moves the converted content so as to display the converted content in the screen as much as possible (step S906), and the processing proceeds to step S99. Thereby, it is possible for the adjustment unit 233 to perform at least one or more adjustments out of the reduction and the movement of the content.

In this manner, if the superimposed data includes a character, the display control device 200 does not change the size of the superimposed data. As a result, it is possible for the display control device 200 to reduce deterioration of the readability of a character included in the superimposed data, that is to say, the content.

In this regard, in the second embodiment, a description has been given of the case where if there is a superimposed part of the converted content outside the screen, and a relationship of h_{c}>αH_{D} is satisfied, the center of the screen and the center of the content are matched as the movement destination position of the content. However, the present disclosure is not limited to this. For example, the center of the content may come closer to the AR marker than to the center of the screen, or may come closer to the opposite side to the AR marker. Further, if rotation is “OK” as the attribute of the content, the content may be rotated.

Also, in each of the above-described embodiments, if there are a plurality of contents, the content adjustment processing is performed for each content and the result is displayed on the screen. However, the present disclosure is not limited to this. For example, a content located near to the center of the screen may be moved, and a content located far from the center of the screen may be displayed by only an arrow indicating the movement. Further, if there are a plurality of contents that are far from the center of the screen, the contents may be moved in the screen regardless of whether or not the contents overlap each other.

Also, in each of the above-described embodiments, capturing an image and displaying a superimposed image are performed by the display control device 100 or 200 alone. However, the present disclosure is not limited to this. For example, a head mounted display (HMD) may be connected to the display control device 100 or 200, and a captured image may be displayed on the HMD, or the HMD alone may perform the display control processing and the content adjustment processing.

Also, each component of each unit illustrated in FIG. 1 or FIG. 9 does not have to be physically configured as illustrated in FIG. 1 or FIG. 9. That is to say, a specific form of distribution and integration of each unit is not limited to that illustrated in FIG. 1 or FIG. 5. It is possible to configure all of or a part of them by functionally or physically distributing of integrating them in any units in accordance with various loads, a use state, or the like. For example, the recognition unit 131 and the conversion unit 132 may be integrated. Also, each processing illustrated in FIG. 7 or FIG. 16 is not limited to the order described above. Each processing may be performed at the same time, or the order of the processing may be replaced within a range in which the processing contents do not conflict.

Further, all of or any part of the various processing functions performed by each device may be carried out by a CPU (or a microcomputer, such as an MPU, a microcontroller unit (MCU), or the like). Also, it goes without saying that all of or any part of the various processing functions may be performed by programs that are analyzed and executed by a CPU (or a microcomputer, such as an MPU, an MCU, or the like), or by wired logic hardware.

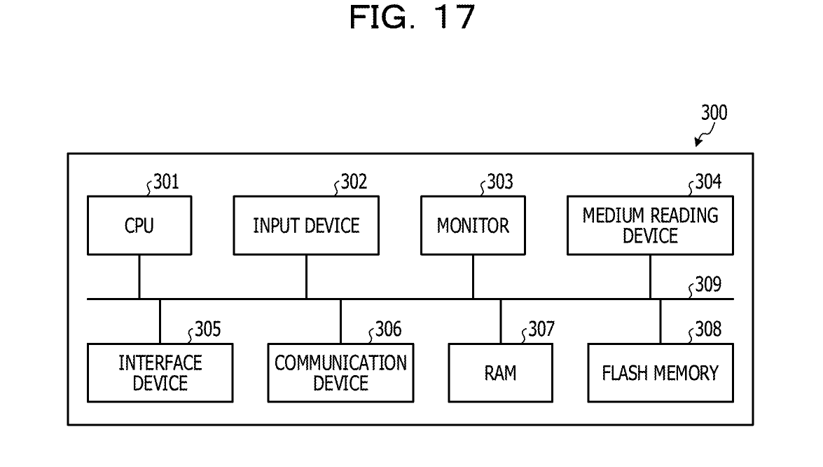

Incidentally, it is possible to realize the various kinds of processing described in the embodiments by executing a program prepared in advance. Thus, in the following, a description will be given of an example of a computer that executes the same functions as those in the above-described embodiments. FIG. 17 is a diagram illustrating an example of a computer that executes a display control program.

As illustrated in FIG. 17, a computer 300 includes a CPU 301 that performs various operation processing, an input device 302 that receives data input, and a monitor 303. Also, the computer 300 includes a medium reading device 304 that reads a program, or the like from a storage medium, an interface device 305 for connecting to various devices, and a communication device 306 that wiredly or wirelessly connects to the other information processing apparatuses, and the like. Also, the computer 300 includes a RAM 307 that temporarily stores various kinds of information and a flash memory 308. Also, the individual devices 301 to 308 are connected to a bus 309.

The flash memory 308 stores a display control program having the same functions as those of the individual processing units of the recognition unit 131, the conversion unit 132, the adjustment units 133 or 233, and the display control unit 134 that are illustrated in FIG. 1 or FIG. 9. Also, the flash memory 308 stores various kinds of data that are used for realizing the content storage unit 121, the content attribute storage unit 122, and the display control program. The input device 302 receives input of various kinds of information, for example, operation information, or the like from a user of the computer 300. The monitor 303 displays various screens, for example, display screens, and the like to the user of the computer 300. For example, the camera 111, and the like are connected to the interface device 305. The communication device 306 is connected to, for example, an unillustrated network having the same functions as the communication unit 110 illustrated in FIG. 1, and exchanges various kinds of information with an unillustrated server.

The CPU 301 reads the individual programs stored in the flash memory 308, loads the programs in the RAM 307, and executes the programs so as to perform various kinds of processing. Also, it is possible for these programs to cause the computer 300 to function as the recognition unit 131, the conversion unit 132, the adjustment unit 133 or 233, and the display control unit 134 that are illustrated in FIG. 1 or FIG. 9.

In this regard, the above-described display control programs do not have to be stored in the flash memory 308. For example, the programs stored in a storage medium that is readable by the computer 300 may be read and executed by the computer 300. The storage medium that is readable by the computer 300 corresponds to a portable recording medium, for example, a CD-ROM, a DVD disc, a Universal Serial Bus (USB) memory, or the like, a semiconductor memory, such as a flash memory, or the like, or a hard disk drive, or the like. Also, the display control program may be stored in a device connected to a public line, the Internet, a LAN, or the like, and the computer 300 may read the display control program from these and may execute the display control program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium storing a display control program that causes a computer to execute a process, the process comprising:
detecting a reference object is included in a captured image;
obtaining superimposed data corresponding to the reference object from a memory;
determining whether the superimposed data is entirely displayable in a predetermined area of an image when the superimposed data is superimposed on the image at a specified position with a specified size, the specified position being determined based on a position of the reference object in the image, the specified size being determined based on a size of the reference object;
superimposing the superimposed data on the image at the specified position with the specified size when the superimposed data is entirely displayable in the predetermined area; and
superimposing a modified superimposed data on the image when the superimposed data is not entirely displayable in the predetermined area, the modified superimposed data being the superimposed data of which at least one of a size and a position is changed from the specified position and the specified size.

2. The non-transitory computer-readable storage medium according to claim 1, wherein
the superimposed data is stored in the memory in association with attribute information indicating whether a modification of the superimposed data is permitted; and wherein
the superimposing of the modified superimposed data is prevented when the attribute information indicates that the modification of the superimposed data is not permitted.

3. The display control method according to claim 2, wherein the attribute information includes at least one of an indicator indicating modification of a rotation of the superimposed data is permitted, modification of a size of the superimposed data is permitted, and modification of a location of the superimposed data is permitted.

4. The display control method according to claim 2, further comprising:
obtaining identification information from the reference object;
searching the memory based on the identification information of the reference object to obtain the superimposed data associated with the reference object and the attribute information of the superimposed data.

5. The display control method according to claim 2, wherein the superimposed data is modified so as to superimpose as much of the modified superimposed data on the image as permitted based on constraints within the attribute information.

6. The non-transitory computer-readable storage medium according to claim 1, wherein
a modification of the specified size is prevented when the superimposed data includes a character.

7. The non-transitory computer-readable storage medium according to claim 1,
wherein the superimposing of the modified superimposed data further includes superimposing display information on the image, the display information indicating that the modified superimposed data has been modified.

8. The non-transitory computer-readable storage medium according to claim 7, wherein the display information indicates the modified superimposed data corresponds to the reference object.

9. The non-transitory computer-readable storage medium according to claim 1, wherein
the superimposed data is modified based on a fixed value when a width of the superimposed data is larger than a product of a width of the predetermined area and the fixed value or when a height of the superimposed data is larger than a product of a height of the predetermined area and the fixed value.

10. The non-transitory computer-readable storage medium according to claim 1, wherein
the predetermined area is an angle of view of the image.

11. The non-transitory computer-readable storage medium according to claim 1, wherein the modified superimposed data includes a modification to a rotation of the superimposed data.

12. The non-transitory computer-readable storage according to claim 1, wherein
the superimposed data includes a character not displayable within the predetermined area; and wherein
the modified superimposed data is modified such that the character is included within the predetermined area.

13. The non-transitory computer-readable storage medium according to claim 1, wherein
the reference object is an Augmented Reality (AR) marker; and wherein
the process further comprises displaying the superimposed data or the modified superimposed data on an AR device.

14. A display control device comprising:
a memory; and
a processor coupled to the memory and the processor configured to execute a process, the process including:
detecting a reference object is included in a captured image;
obtaining superimposed data corresponding to the reference object and storing the superimposed data in the memory;
determining whether the superimposed data is entirely displayable in a predetermined area of the image when the superimposed data is superimposed on the image at a specified position with a specified size, the specified position being determined based on a position of the reference object in the image, the specified size being determined based on a size of the reference object;
superimposing the superimposed data on the image at the specified position with the specified size when the superimposed data is entirely displayable in the predetermined area; and
superimposing a modified superimposed data on the image when the superimposed data is not entirely displayable in the predetermined area, the modified superimposed data being the superimposed data of which at least one of a size and a position is changed from the specified position and the specified size.

15. A display control method executed by a computer, the method comprising:
detecting a reference object is included in a captured image;
obtaining superimposed data corresponding to the reference object and storing the superimposed data in the memory;
determining whether the superimposed data is entirely displayable in a predetermined area of the image when the superimposed data is superimposed on the image at a specified position with a specified size, the specified position being determined based on a position of the reference object in the image, the specified size being determined based on a size of the reference object;
superimposing the superimposed data on the image at the specified position with the specified size when the superimposed data is entirely displayable in the predetermined area; and
superimposing a modified superimposed data on the image when the superimposed data is not entirely displayable in the predetermined area, the modified superimposed data being the superimposed data of which at least one of a size and a position is changed from the specified position and the specified size.
